(19) United States
(12) Patent Application Publication
(10) Pub. No.: US 2009/0209284 A1
(43) Pub. Date: Aug. 20, 2009

(54) Robotic cellular phone

(76) Inventors: Seung-Woo Kim, Asan-si (KR); Jae-Il Choi, Asan-si (KR); Yong-Rae Jung, Asan-si (KR)

Correspondence Address: LATHROP & GAGE LLP, 4845 PEARL EAST CIRCLE, SUITE 201, BOULDER, CO, 80301, US

(21) Appl. No.: 10/575,509

(22) PCT Filed: Dec. 5, 2003
(86) PCT No.: PCT/KR2003/002650

§ 371 Date: Nov. 24, 2008

(30) Foreign Application Priority Data
Oct. 13, 2003 (KR) 1020030070900

(51) Int. Cl. H04M 1/00

(52) U.S. Cl. 455/556.1; 901/1

(57) ABSTRACT

A robotic cellular phone is disclosed. The robotic cellular phone includes a self-environmental recognition function part, a mobility function part, and an emotion function part. The self-environmental recognition function part is for recognizing an external environment by a photo sensor for a sensing luminosity of a surrounding device; a temperature sensor for sensing temperatures of the surrounding device; and a touch sensor for sensing a touch between a human and the surrounding device. The mobility function part is for moving the antenna to an optimum location to increase a sending or receiving signal sensitivity and for opening and closing a folder by using a plurality of wheels formed on a part of rechargeable battery. The emotion function part is for identifying a sender by comparing data between sender telephone information included a receiving signal and a telephone data stored in an internal memory; and for making a different vibration according to an emotional pattern by modeling a frequency of a vibrator based on a major or minor key harmony or for spraying perfume through a micro-nozzle.

### TECHNICAL FIELD

The present invention relates to a potable communication phone having a robotic function (hereinafter “cellular phone”), and more particularly, to a human-friendly cellular phone having functions of mobility, emotion, and recognition.

### BACKGROUND ART

Recently, a cellular phone has become one of core information technologies (hereinafter “IT”) and is very important business in the industry and economy. However, competitiveness of the cellular phone is being more severe, so that new technologies having new concept should be developed.

A robot technology (hereinafter “RT”) along with the IT is another promising leading edge technology. There are various types of a recent robot, e.g., a personal robot, a welfare robot, and a service robot having functions of soft computing, human interface, mutual operating technology, voice recognition, object recognition, user intention recognition, etc. Especially, an entertainment robot for games and education is actively developed.

According to a report published by Mitsubishi Research Institute of Japan in 2000, a market size in 2015 of RITS (RT & IT Systems) being merged IT with RD will be 5-times compared to a present market size of the IT. Further, a recent report of IEEE predicts that one person will have one robot in 10 years.

Therefore, it is increasingly requested to develop a new type robotic cellular phone for preparing future society and culture.

### SUMMARY OF THE INVENTION

It is therefore an object of the present invention to provide a robotic cellular phone having a personal robot function in a cellular phone.

It is therefore another object of the present invention to provide a robotic cellular phone having personal service and entertainment functions of a robot.

According to an embodiment of the present invention, a robotic cellular phone includes: a plurality of wheels formed on a part of rechargeable battery; a wheel driving motor for supplying power to the plurality of wheels; an antenna driving motor for supplying power to an antenna and for moving the antenna to an optimum location; a folder driving motor for supplying power for opening, closing, and rotating a folder in response to a receiving signal or a termination signal by pushing an ending button; and a micro-processor for outputting control signals for controlling operations of the wheel driving motor, the antenna driving motor, and the folder driving motor.

According to another embodiment of the present invention, a robotic cellular phone includes: a vibrating motor for making a different vibration according to an emotional pattern by modeling a frequency of a vibrator based on a major or minor key harmony; a perfume spraying device for spraying perfume through a micro-nozzle; and a micro-processor for identifying a sender by comparing data between sender telephone information included a receiving signal and a telephone data stored in an internal memory and for controlling operations of the vibrating motor and the perfume spraying device.

According to still another embodiment of the present invention, a robotic cellular phone includes: a photo sensor for a sensing luminosity of a surrounding device; a temperature sensor for sensing temperatures of the surrounding device; a touch sensor for sensing a touch between a human and the surrounding device; and a micro-processor for outputting a communication control signal in response to outputs of the photo sensor, the temperature sensor, and the touch sensor.

### BRIEF DESCRIPTION OF THE DRAWINGS

The above objects and other advantages of the present invention will become more apparent by describing in detail preferred embodiments thereof with reference to the attached drawings in which:

FIG. 1 is a schematic diagram of a robotic cellular phone according to an exemplary embodiment of the present invention; and

FIG. 2 is a block diagram of a robotic cellular phone according to an embodiment of the present invention.

### BEST MODE FOR CARRYING OUT THE INVENTION

Hereinafter, preferred embodiments of the present invention will be described in detail with reference to the accompanying drawings. It should be noted that like reference numerals are used for designation of like or equivalent parts or portion for simplicity of illustration and explanation.

Hereinafter, a robotic cellular phone and its function will be described in detail with reference to the accompanying drawings.

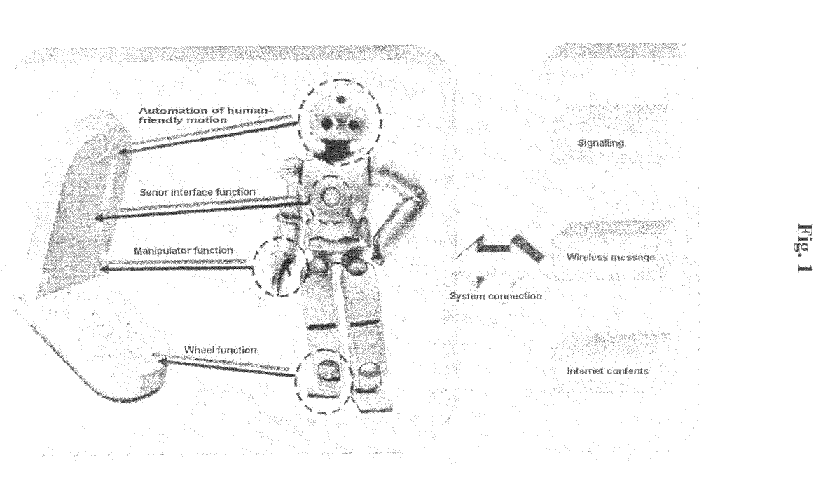

FIG. 1 is a schematic diagram of a robotic cellular phone according to an embodiment of the present invention. Referring to FIG. 1, an embodiment of the present invention incorporates a conventional cellular phone with a personal robot for incorporation of a personal service function and an entertainment function of the robot. Specially, as a personal robot function can be connected to the cellular phone according to a communication system, it greatly affects an industrial field. Further, as a personal robot applied to develop basic cellular phone technologies works in the same field of human, it is different from an industrial robot. The industrial robot is generally used in the field of simplified and repeated tasks, and it performs predetermined tasks apart from humans in a limited well-arranged environment. However, the robotic cellular phone according to an embodiment of the present invention can be applied for offices or home in which the tasks are not fixed and are near humans. Further, the robotic cellular phone of an embodiment of the present invention does not perform simplified and repeated tasks but support or assist humans. Furthermore, the robotic cellular phone includes a human-friendly function and functions of emotional modeling, a communication related technology, and the like.

According to an embodiment of the present invention, the robotic cellular phone includes following functions:

i) a mobility function for moving an equipment by driving a wheel formed on a part of battery; moving an antenna to an optimum location for increasing sensitivities of reception and transmittance; and opening, closing, and rotating a folder;

ii) an emotion function for identifying a sender by comparing data between sender telephone information included in a receiving signal and a telephone data stored in an internal memory; and making a different vibration according to an emotional pattern by modeling a frequency of a vibrator based on a major or minor key harmony and/or spraying perfume through a micro-nozzle; and

iii) a self-environmental recognition function based on signals from a photo sensor for sensing a luminosity of a surrounding device; a temperature sensor for sensing temperatures of the surrounding device; and a touch sensor for sensing a touching between a human and the surrounding device.

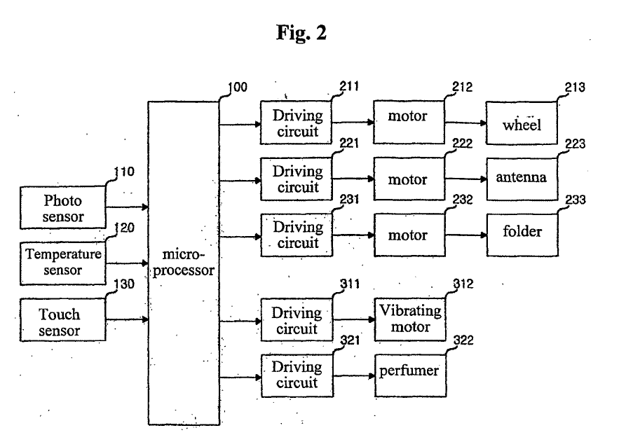

FIG. 2 is a block diagram of the robotic cellular phone according to an embodiment of the present invention.

Referring to FIG. 2, the robotic cellular phone includes a mobility function part, an emotion function part, a self-environmental recognition function part, and a micro-processor 100. Alternatively, according to an embodiment of the present invention, the robotic cellular phone can include the mobility function part and the micro-processor 100, or the emotion function part and the micro-processor 100, or the self-environmental recognition function part and the micro-processor 100. It is to be appreciated that combinations among the mobility function part, the emotion function part, and the self-environmental recognition function part can be possible.

The mobility function part includes: a plurality of wheels 213 formed on a part of rechargeable battery; a wheel driving motor 212 for supplying power to the plurality of wheels 213; an antenna driving motor 222 for supplying power to an antenna 223 and for moving the antenna 223 to an optimum location; a folder driving motor 232 for supplying power for opening, closing, and rotating a folder 233 in response to a signal such as a receiving signal or a termination signal by pushing an ending button; and respective driving circuits 221, 221, 231 for controlling operations of the wheel driving motor 212, the antenna driving motor 222, and the folder driving motor 232, respectively. The micro-processor 100 controls the respective driving circuits 221, 221, 231.

The emotion function part includes: a vibrating motor 312 for making a different vibration according to an emotional pattern by modeling a frequency of a vibrator based on a major or minor key harmony; a perfume spraying device for spraying perfume through a micro-nozzle (not shown); and respective driving circuits 311, 321 for identifying a sender by comparing data between sender telephone information included a receiving signal and a telephone data stored in an internal memory (not shown) and for controlling operations of the vibrating motor 312 and/or the perfume spraying device 322. The micro-processor 100 controls the respective driving circuits 311, 321.

The self-environmental recognition function part includes: a photo sensor 110 for sensing a luminosity of a surrounding device; a temperature sensor 120 for sensing temperatures of the surrounding device; and a touch sensor 130 for sensing a touch between a human and the surrounding device. The micro-processor 100 controls outputs of the photo sensor 110, the temperature sensor 120, and the touch sensor 130.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or sprit of the invention.

### INDUSTRIAL APPLICABILITY

According to an embodiment of the present invention, the robotic cellular phone incorporates a robotic function with conventional cellular phone technologies for utilizing the conventional cellular phone infra-structure, technologies, and design.

Advantageously, knowledgeable and emotional robot functions can be incorporated into a cellular phone, thereby embedding various functions into the cellular phone.

What is claimed is:

1. A robotic cellular phone, comprising:
a plurality of wheels formed on a part of rechargeable battery;
a wheel driving motor for supplying power to the plurality of wheels;
an antenna driving motor for supplying power to an antenna and for moving the antenna to an optimum location;
a folder driving motor for supplying power for opening, closing, and rotating a folder in response to a receiving signal or a termination signal by pushing an ending button; and
a micro-processor for outputting control signals for controlling operations of the wheel driving motor, the antenna driving motor, and the folder driving motor.

2. A robotic cellular phone, comprising:
a vibrating motor for making a different vibration according to an emotional pattern by modeling a frequency of a vibrator based on a major or minor key harmony;
a perfume spraying device for spraying perfume through a micro-nozzle; and
a micro-processor for identifying a sender by comparing data between sender telephone information included a receiving signal and a telephone data stored in an internal memory and for controlling operations of the vibrating motor and the perfume spraying device.

3. A robotic cellular phone, comprising:
a photo sensor for a sensing luminosity of a surrounding device;
a temperature sensor for sensing temperatures of the surrounding device;
a touch sensor for sensing a touch between a human and the surrounding device; and
a micro-processor for outputting a communication control signal in response to outputs of the photo sensor, the temperature sensor, and the touch sensor.

4. A robotic cellular phone, comprising:
a self-environmental recognition function part for recognizing an external environment by a photo sensor for a sensing luminosity of a surrounding device; a temperature sensor for sensing temperatures of the surrounding device; and a touch sensor for sensing a touch between a human and the surrounding device;
a mobility function part for moving the antenna to an optimum location to increase a sending or receiving signal sensitivity and for opening and closing a folder by using a plurality of wheels formed on a part of rechargeable battery; and
an emotion function part for identifying a sender by comparing data between sender telephone information included a receiving signal and a telephone data stored in an internal memory; and for making a different vibration according to an emotional pattern by modeling a frequency of a vibrator based on a major or minor key harmony or for spraying perfume through a micro-nozzle.

5. A robotic cellular phone of claim 4, wherein the mobility function part comprises:
a plurality of wheels formed on a part of rechargeable battery;
a wheel driving motor for supplying power to the plurality of wheels;
an antenna driving motor for supplying power to an antenna and for moving the antenna to an optimum location;
a folder driving motor for supplying power for opening, closing, and rotating a folder in response to a receiving signal or a termination signal by pushing an ending button; and
a micro-processor for outputting control signals for controlling operations of the wheel driving motor, the antenna driving motor, and the folder driving motor.

6. A robotic cellular phone of claim 4, wherein the emotion function part comprises:
a vibrating motor for making a different vibration according to an emotional pattern by modeling a frequency of a vibrator based on a major or minor key harmony;
a perfume spraying device for spraying perfume through a micro-nozzle; and
a micro-processor for identifying a sender by comparing data between sender telephone information included a receiving signal and a telephone data stored in an internal memory and for controlling operations of the vibrating motor and the perfume spraying device.

7. A robotic cellular phone of claim 4, wherein the recognition function part comprises:
a photo sensor for a sensing luminosity of a surrounding device;
a temperature sensor for sensing temperatures of the surrounding device;
a touch sensor for sensing a touch between a human and the surrounding device; and
a micro-processor for outputting a control signal in response to outputs of the photo sensor, the temperature sensor, and the touch sensor.
